(19) United States
(12) Patent Application Publication
(10) Pub. No.: US 2011/0121093 A1
(43) Pub. Date: May 26, 2011

(54) Apparatus And Methods For Making Analyte Particles

(75) Inventor: Joseph A. Jarrell, Newton Highlands, MA (US)

(73) Assignee: WATERS TECHNOLOGIES CORPORATION, Milford, MA (US)

(21) Appl. No.: 12/920,384

(22) PCT Filed: Mar. 13, 2009
(86) PCT No.: PCT/US09/37043

§ 371 Date: Dec. 9, 2010

Related U.S. Application Data
(60) Provisional application No. 61/037,893, filed on Mar. 19, 2008.

(51) Int. Cl. B05B 1/24

(52) U.S. Cl. 239/13; 239/135

(57) ABSTRACT

A device for making particulate analyte molecules comprising a nebulizer producing a plume of liquid droplets, a vessel having a chamber to receive the plume in which the chamber has a nebulization section, a desolvation section. The nebulization section is cooled to form a condensed waste from a portion of said plume. The desolvation section is heated to form solvent gas molecules and particulate analyte molecules.

### CROSS-REFERENCE TO RELATED APPLICATIONS

The application claims priority to U.S. Provisional Patent Application No. 61/037,893, filed Mar. 19, 2008, the entire contents of which are incorporated herein by reference.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO SEQUENCE LISTING

None.

### BACKGROUND

To facilitate an understanding of the present invention, certain words and phrases will be defined. An “analyte” is a compound that is of interest in the sense that one desires to detect its presence or absence or the quantity in a sample. The term “sample” is used in a broad sense to denote any material, solution, mixture, compound, whether gas, liquid or solid that one may wish to investigate. Samples may be of biological or non-biological in origin. Biological samples may comprise tissues or fluids.

Evaporative processes are those in which a liquid undergoes a phase transition to gas. Condensation processes are those in which a gas undergoes a phase transition to a liquid. The contrast between these two processed is highlighted in evaporative light scattering processes and condensation nucleation light scattering processes.

In evaporative light scattering processes solutions carrying analyte molecules are evaporated leaving particles of analyte. These analyte particles are subjected to beams of light which beams of light are scattered. The degree of scattering is indicative of the presence or absence of the analyte. A detector for determining the presence of an analyte by evaporative light scattering processes is known as an evaporative light scattering detector or ELSD.

In condensation nucleation light scattering processes, particles of analyte molecules are a nucleus for condensation. Condensation of a gas to a liquid about the analyte particle allows the analyte particle to have a larger effective size . This larger effective size and the changes rendered by the condensed liquid refracts beams of light in the presence of the analyte. Analyte particles as small a two nanometers in diameter can be grown to 3000 nanometers or more in the presence of a condensing vapor. A detector for determining the presence of an analyte by condensation nucleation processes is known as a condensation nucleation light scattering detector or CNLSD.

Chromatography is a method of separating compounds in a solution from each other. The compounds separate on the basis of the affinity of each compound to two different phases or materials. For example, in liquid chromatography, compounds held in a liquid solution exhibit different affinity for a solid material. In gas chromatography, compounds exhibit a different affinity for a solid material. The solid material is often referred to as the immobile or stationary phase and the gas or liquid as the mobile phase.

Liquid chromatography performed under pressure is known as high performance liquid chromatography or HPLC. HPLC uses a stationary phase of solid particles or a permeable matrix of solid material in a column or cartridge column. The column or cartridge receives the sample as a solution under pressure. Compounds are separated in the column and the analyte can be isolated and detected.

It is difficult to couple chromatography techniques with condensation nucleation light scattering detection due to the volume of liquid generated by HPLC separation.

### SUMMARY OF INVENTION

Embodiments of the present invention feature methods and apparatus for performing condensation nucleation for use in light scattering detection. The methods and apparatus are particularly suitable for coupling to chromatographic methods and apparatus.

One embodiment of the apparatus is a device for making particulate analyte molecules for condensation nucleation light scattering detection. The analyte molecules are potentially present in solution or suspension in a liquid sample having solvent. The apparatus has a nebulizer, a vessel, cooling means and heating means. The nebulizer is for being placed in fluid communication with a source of sample. The nebulizer produces a plume of liquid droplets, with the plume having dimensions of length and diameter. The vessel has at least one wall having an interior surface defining a chamber and an exterior surface. The chamber is in fluid communication with the nebulizer to receive the plume. The chamber has a nebulization section, and a desolvation section, a waste port, a analyte molecule port, and a gas inlet. The nebulization section is proximal to the nebulizer and has a length at least as great as the plume. The desolvation section is distal to the nebulizer to receive droplets and analyte molecules from the nebulization section, forming particulate analyte molecules and solvent gas molecules and passing particulate analyte molecules to the analyte port. The analyte port is an opening in the desolvation section for being placed in fluid communication with a condensation nucleation detector. The gas inlet is an opening having a position in at least one of the nebulization section and desolvation section close to the plume for receiving an inert gas from an inert gas source. The inert gas carries particulate analyte molecules and solvent gas molecules to the analyte port. The waste port is an opening in the nebulization section or the desolvation section to receive a portion of the plume that condenses forming a condensed waste. Cooling means is in thermal communication with the nebulization section to cool a portion of the plume to form a condensed waste. Heating means is in thermal communication with the desolvation section to heat solvent to form solvent gas molecules and particulate analyte molecules. The particulate analyte molecules are carried to the analyte port for being placed in communication with a condensation light scattering detector.

Embodiments of the present apparatus are particularly suited for placing the nebulizer in communication with a liquid chromatography system. The device of the present invention can rapidly and efficiently remove a large volume of liquid from the plume that condenses. Removal of condensed waste is facilitated with the waste port at a low point or bottom of the chamber. And, preferably, the waste port is located at the nebulization section.

As used herein, the term “fluid communication” means allowing fluid to pass between or through as in plumbed or piped together. The term “thermal communication” means allowing thermal energy to be transferred or passed through. The term “signal communication”, used later in this application, means receiving or sending a data signal or command signal of a electrical, optical or radio nature as one would send or receive communications by wire, optical fiber or wireless networks.

The term “plume” is used to denote a spray or a fluid stream in a standing fluid or fluid which is not moving at the speed of the spray or stream. The plume dissipates when the droplets comprising the spray or stream are substantially equally distributed across the cross section of the vessel. A preferred nebulization section extends a distance of the plume to four times the length of the plume.

Cooling means may take several forms including a cooled grid, mesh one or more bars or radiator in the chamber or a cooled wall comprising the chamber at the nebulization section or a circulation of cooled inert gas introduced into the nebulization section through the gas inlet. These different forms may exist singularly or in combination. A preferred cooling means is a device in thermal communication with the cooled grid, radiator or wall. Inert gases held under pressure will exhibit a loss of thermal energy upon the release of pressure to reduce the temperature of the nebulization section. Cooling means comprising a cooled wall may further comprise fins and channels to expand the surface area and for directing condensed fluid removal.

A preferred cooling means cools the grid, mesh, radiator and/or at least one wall of said nebulization region to a temperature above the freezing temperature of the solvent and below the temperature of the desolvation section. For example, the temperature of the grid, mesh, radiator or wall is within two to twenty degrees Celsius of the freezing temperature of the solvent.

A preferred embodiment has temperature sensing means for monitoring the temperature of the cooling means. Temperature sensing means comprises electrical temperature sensing devices and mechanical thermostats. And, a preferred temperature sensing means comprises electrical temperature sensors which produce a temperature signal.

A preferred embodiment comprises control means in signal communication with the temperature sensing means. The control means receives the temperature signal and compares such temperature signal to a value and sends a command signal to the cooling means to effect further cooling or to allow the nebulization chamber to warm. Suitable control means are computer processing units (CPUs), personal computers, mainframe computers, servers and similar computational devices known in the art. A preferred control means monitors the temperature and composition of the solvents carrying the analyte and sends a command signal to raise or lower the temperature as the solvent changes over time. Solvent changes occur in HPLC where gradients are used.

One embodiment of the device further comprises a condensation nucleation light scattering detector. The condensation light scatter detector is in fluid communication with the analyte port to receive the particulate analyte molecules, if present, and produce a condensation light scattering signal.

A preferred vessel is a cylindrical or elongated conical in shape having a first end and a second end. In conical forms the ends comprise the base and tip. The nebulization section is at one of said first end and second end and the desolvation section is at said remaining end. A preferred vessel has at least one of said nebulization section and said desolvation section coiled. Coiling allows the vessel to be more conveniently sized and improves thermal uniformity. A preferred vessel has a nebulization section having a larger diameter than the diameter of the desolvation section in order to contain the plume and waste.

Embodiments of the present invention further comprise a method of making particulate analyte molecules for condensation nucleation light scattering detection, where the analyte molecules are potentially present in solution or suspension in a liquid sample having solvent. The method comprises the steps of producing a plume of liquid droplets with a nebulizer placed in fluid communication with a source of sample. The plume has dimensions of length and diameter. The nebulizer is also in fluid communication with a chamber of the vessel defined by at least one wall to receive the plume. The chamber has a nebulization section, a desolvation section, a waste port, a analyte molecule port, and a gas inlet. The nebulization section is proximal to the nebulizer and has a length at least as great as the plume. The desolvation section is distal to the nebulizer to receive droplets and analyte molecules from the nebulization section, forming particulate analyte molecules and solvent gas molecules and passing particulate analyte molecules to the analyte port. The gas inlet has a position in at least one of the nebulization section and desolvation section close to the plume which inert gas carries particulate analyte molecules and solvent gas molecules to said analyte port. The waste port is in a position in the nebulization section to receive a portion of the plume that condenses. The method further comprises the step of cooling the nebulization section to cool to form a condensed waste from a portion of said plume. And, the method comprises the step of heating the desolvation section to heat solvent to form solvent gas molecules and particulate analyte molecules. The particulate analyte molecules are carried to the analyte port for being placed in communication with a condensation light scattering detector.

Preferably, the cooling means is a wall of the chamber, mesh, grid or radiator or cooled inert gas. A preferred cooling means is a Peltier device coupled to at least one of the group comprising the chamber wall, grid, mesh or readiator.

Preferably, the cooling cools the wall, mesh, grid or radiator of the nebulization region to a temperature above the freezing temperature of the solvent and below the temperature of the desolvation section. A preferred temperature is within five to twenty degrees Celsius of the freezing temperature.

The present method is well suited for use with a chromatograph in fluid communication with the nebulizer to provide a source of sample. The present method removes the excess liquid in the form of a condensed waste.

The present method is well suited for used with a condensation nucleation light scattering detector in fluid communication with the analyte port to receive the particulate analyte molecules. In the presence of the analyte particles, the condensation nucleation light scatter detector produces a condensation light scattering signal.

These and other features and advantages will be apparent to those skilled in the art upon reading the detailed description of the invention that follows and upon viewing the figures which are briefly described below.

### BRIEF DESCRIPTION OF THE DRAWINGS

FIG. 1 depicts an apparatus embodying features of the present invention, in partial cross-section; and

FIG. 2 depicts in schematic form an apparatus embodying features of the present invention.

### DETAILED DESCRIPTION OF THE INVENTION

Embodiments of the present invention will be described in detail as methods and apparatus for forming analyte particles for condensation nucleation for use in light scattering detection from samples originating from a liquid chromatograph. However, embodiments of the present invention have application in other techniques as well. For example, the apparatus can be used without a liquid chromatograph or without a condensation nucleation apparatus, or it may be used in conjunction with other particle detection devices including those that use electrical means for detection such as the CoronaCad sold by ESA Biosciences of Chelmsford, Mass.

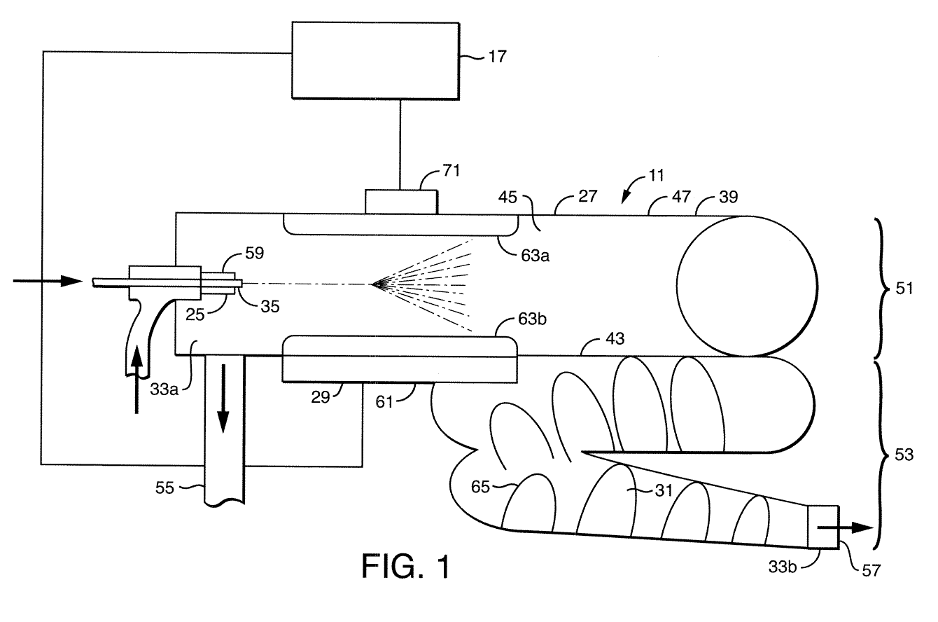

Turning now to FIG. 1, a device for making particulate analyte molecules, generally designated by numeral 11, is depicted. The device makes analyte particles for condensation nucleation light scattering detection. The analyte molecules are potentially present in solution or suspension in a liquid sample having solvent.

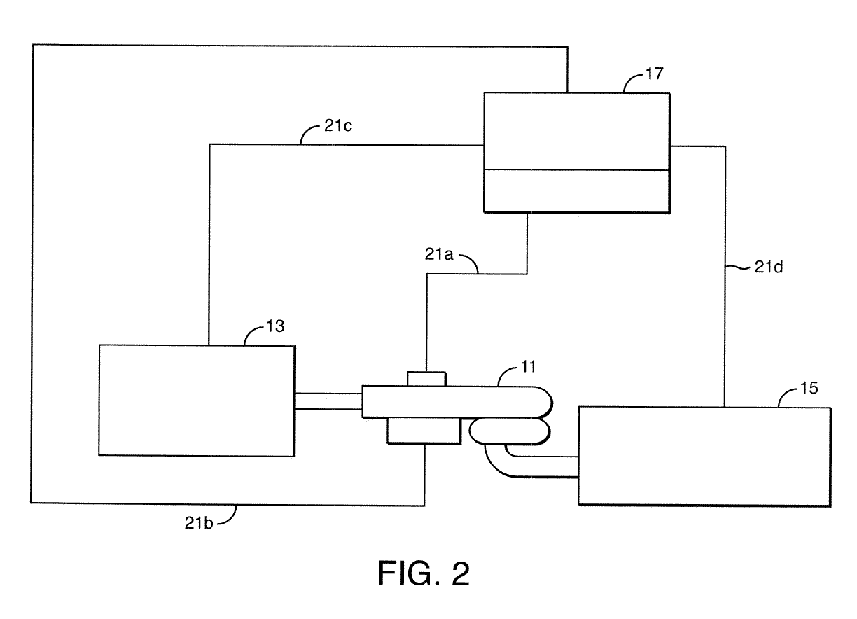

Turning briefly to FIG. 2, the device 11 receives sample from a liquid chromatographic system 13 and directs the analyte particles to a condensation nucleation light scattering apparatus 15. Liquid chromatographic systems are well known and sold by several venders under the tradenames of ALLIANCE®, ACQUITY® (Waters Corporation, Milford, Mass.), 1100® Agilent (Santa Clara, Calif.). Chromatography system 13 separates compounds in mixtures into separate concentrations in solution.

Condensation nucleation light scattering apparatus 15 are known in the art and sold by several vendors including those sold under the trade designations Model #3776 and Model #3772 (TSI, Shorewood, Minn.). Condensation nucleation light scattering apparatus takes analyte particles and places such particles in a supersaturated atmosphere in which the particles provide a nucleus for droplet formation. Particles of a small size, otherwise not detectable by light scattering, can and are detected by light scattering due to the additional size volume and changes in composition.

The device 11, chromatographic system 13 and condensation nucleation light scattering apparatus 15 are in signal communication with a control means 17. Suitable control means are computer processing units (CPUs), personal computers, mainframe computers, servers and similar computational devices known in the art. Computers are well known in the art and are available from several venders such as Dell, Inc. (Round Rock, Tex.) and Apple Computer (Cupertino, Calif.).

Signal communication is depicted with lines 21a, 21b, 21c and 21d. However, those skilled in the art will readily recognize that signal communication can be carried out with fiber optical devices, infrared devices and radio wireless communication devices [not shown].

Returning now to FIG. 1, the device 11 has the following major elements: nebulizer 25, a vessel 27, cooling means 29 and heating means 31. The nebulizer 25 is for being placed in fluid communication with a source of sample.

Nebulizer 25 produces a plume of liquid droplets, with the plume having dimensions of length and diameter. The plume is depicted as dotted lines emanating from the nebulizer 25. As depicted, the plume dissipates or loses its distinctiveness when the droplets comprising the spray or stream are substantially equally distributed across the cross section of the vessel.

Nebulizer 25 comprises a conduit 35 which is placed in communication with a source of sample, which is depicted in FIG. 2 as chromatography system 13. The conduit 35 is made of an inert material such as glass, plastic or metal, for example stainless steel. Although the nebulizer 25 depicted is equipped with a conduit 35, other nebulizers [not shown] can be substituted, for example a slurry nebulizer, or Babington-principle nebulizer, or impactor based nebulizers (See, e.g. U.S. Pat. No. 6,568,245 col 6 lines 19-49, incorporated herein by reference).

Vessel 27 has at least one wall 39 having an interior surface 43 defining a chamber 45 and an exterior surface 47. The chamber 45 is in fluid communication with the nebulizer 25 to receive the plume. The vessel 27 is preferably made of a thermally conductive material such as metal, including steel, brass, titanium, copper, and stainless steel.

Vessel 27 is a cylindrical or an elongated conical shape having a first end 33a and a second end 33b. In conical forms the ends comprise the base and tip.

The chamber 45 has a nebulization section 51, and a desolvation section 53, a waste port 55, a analyte molecule port 57, and a gas inlet 59. The nebulization section 51 is proximal to the nebulizer 25, at the first end 33a of the vessel 27, and has a length at least as great as the plume. The nebulization section 51 is preferably about one to five times the length of the plume and is typically in the range of about five to twenty five centimeters in length.

The desolvation section 53 is distal to the nebulizer 25 to receive droplets and analyte molecules from the nebulization section 51, forming particulate analyte molecules and solvent gas molecules and passing particulate analyte molecules to the analyte port 57.

A preferred vessel has at least one of the nebulization section 51 and the desolvation section 55 coiled. Coiling allows the vessel to be more conveniently sized and improves thermal uniformity. As depicted, vessel 27 has a desolvation section 55 coiled in a generally downward manner and has a length of approximately five to fifty centimeters. The nebulization section 51 has a larger diameter than the diameter of the desolvation section 53 in order to contain the plume and waste.

The analyte port 57 is an opening in the desolvation section 53 for being placed in fluid communication with a condensation nucleation detector 15, as best seen in FIG. 2.

Returning now to FIG. 1, the gas inlet 59 is an opening having a position in at least one of the nebulization section and desolvation section close to the plume for receiving an inert gas from an inert gas source [not shown]. The inert gas carries particulate analyte molecules and solvent gas molecules to the analyte port 57. As depicted, the gas inlet 57 is concentrically positioned about the conduit 35 of the nebulizer 25 to facilitate the formation of the plume.

The waste port 55 is an opening in the nebulization section 51 or the desolvation section 53 to receive a portion of the plume that condenses forming a condensed waste. The waste port 55 is depicted in the nebulization section 51 at a low point to facilitate draining of the waste liquid.

Cooling means 29 in the form of a Peltier device 61 in thermal communication with the wall 39 at the nebulization section 51 is used to cool a portion of the plume to form a condensed waste. The cooling means may also take the form of a channels, mesh, grid or a radiator [not shown] placed in the path of the plume. The channels, mesh, grid, one or more bars, or radiator are thermally coupled to a cooling device such as a Peltier device or other refrigeration device [not shown]. As depicted, the wall 39 in the nebulization section 51 has fins, of which only two are shown, 63a and 63b. Fins 63a and 63b are angled to direct the condensed waste to the waste port 55 and to direct analyte particles and droplets into the desolvation section 53.

Cooling means 29 cools the grid, mesh, radiator and/or at least one wall having channels or fins 63a and 63b, of said nebulization region to a temperature above the freezing temperature of the solvent and below the temperature of the desolvation section. For example, the temperature of the grid, mesh, radiator or wall is within two to twenty degrees Celsius of the freezing temperature of the solvent.

As depicted, the device 11 has temperature sensing means 71 for monitoring the temperature of the cooling means 29. Temperature sensing means 71 comprises electrical temperature sensing devices and mechanical thermostats known in the art and available from numerous sources. The temperature sensing means 71 is an electrical temperature sensor which produces a temperature signal. The temperature sensing means is in signal communication with the control means 17.

The control means 17 receives the temperature signal and compares such temperature signal to a value and sends a command signal to the cooling means 29 to effect further cooling or to allow the nebulization chamber 51 to warm. The control means 17 may alter the temperature of the cooling means 29 as the solutions entering the nebulizer 25 change over time. These solutions may change due to gradient operation of the chromatographic system 13.

Heating means 31, in the form of heating coils 65, is in thermal communication with the wall 39 of the desolvation section 53 to heat solvent to form solvent gas molecules and particulate analyte molecules. Other heating means may comprise a Peltier device, heated jacket and oven structures. Heating coils 65 comprise wires, tape and other electrical resistive heat generating devices. The particulate analyte molecules are carried to the analyte port 57 for being placed in communication with a condensation light scattering detector.

Embodiments of the device 11 are particularly suited for placing the nebulizer in communication with a liquid chromatography system 13 as depicted in FIG. 2. The device of the present invention can rapidly and efficiently remove a large volume of liquid from the plume that condenses.

Embodiments of the device 11 may be integrated with a condensation nucleation light scattering detector 15 and/or a chromatographic system 13, as depicted in FIG. 2. The condensation light scatter detector 15 is illustrated in fluid communication with the analyte port 57 to receive the particulate analyte molecules, if present, and produce a condensation light scattering signal which is received by the control means 17.

The operation of the present device 11 will be discussed with respect to a method of the present invention. One method of the present invention is directed to making particulate analyte molecules for condensation nucleation light scattering detection. The analyte molecules are potentially present in solution or suspension in a liquid sample having solvent.

The method comprises the steps of producing a plume of liquid droplets with a nebulizer 25 placed in fluid communication with a source of sample such as a chromatographic system 13. The plume has dimensions of length and diameter. The nebulizer 25 is also in fluid communication with a chamber of the vessel defined by at least one wall to receive the plume. The chamber 45 has a nebulization section 51, a desolvation section 53, a waste port 55, a analyte molecule port 57, and a gas inlet 59. The nebulization section 51 is proximal to the nebulizer 25 and has a length at least as great as the plume. The desolvation section 53 is distal to the nebulizer 25 to receive droplets and analyte molecules from the nebulization section 51, forming particulate analyte molecules and solvent gas molecules and passing particulate analyte molecules to the analyte port 57. The gas inlet 59 has a position in at least one of the nebulization section 51 and desolvation section 53 close to the plume which inert gas carries particulate analyte molecules and solvent gas molecules to said analyte port 57. The waste port 55 is in a position in the nebulization section 51 to receive a portion of the plume that condenses. The method further comprises the step of cooling the nebulization section 51 to form a condensed waste from a portion of said plume. And, the method comprises the step of heating the desolvation section 53 to heat solvent to form solvent gas molecules and particulate analyte molecules. The particulate analyte molecules are carried to the analyte port 57 for being placed in communication with a condensation light scattering detector.

Preferably, the cooling cools the nebulization region 51 to a temperature above the freezing temperature of the solvent and below the temperature of the desolvation section 53. A preferred temperature is within five to twenty degrees Celsius of the freezing temperature.

The present method is well suited for use with a chromatographic system 13 in fluid communication with the nebulizer 25. The present method removes the excess liquid in the form of a condensed waste.

The present method is well suited for used with a condensation nucleation light scattering detector 15 in fluid communication with the analyte port 57 to receive the particulate analyte molecules. In the presence of the analyte particles, the condensation nucleation light scatter detector 15 produces a condensation light scattering signal.

Thus, preferred embodiments of the present invention have been described with the understanding that the present invention can be altered and modified without departing from the teaching herein. Thus, the present invention should not be limited to the precise details herein but should encompass the subject matter of the claims that follow and their equivalents.

What is claimed:

1. A device for making particulate analyte molecules, said analyte molecules potentially present in solution or suspension in a liquid sample having solvent, comprising:
a nebulizer for being placed in fluid communication with a source of sample, said nebulizer producing a plume of liquid droplets said plume having dimensions of length and diameter;
a vessel having at least one wall defining a chamber in fluid communication with said nebulizer to receive said plume, said chamber has a nebulization section, a desolvation section, a waste port, a analyte molecule port, and a gas inlet, said nebulization section proximal to said nebulizer and having a length at least as great as the plume, said desolvation section distal to said nebulizer to receive droplets and analyte molecules from said nebulization section, forming particulate analyte molecules and solvent gas molecules and passing particulate analyte molecules to said analyte port, said gas inlet having a position in at least one of said nebulization section and desolvation section close to said plume for receiving an inert gas which inert gas carries particulate analyte molecules and solvent gas molecules to said analyte port, said waste port in a position in said nebulization section to receive a portion of said plume that condenses;
cooling means in thermal communication with said nebulization section to cool said at least one wall to form a condensed waste from a portion of said plume;
heating means in thermal communication with said desolvation section to heat solvent to form solvent gas molecules and particulate analyte molecules, said particulate analyte molecules carried to said analyte port.

2. The device of claim 1 wherein said cooling means is a Peltier device.

3. The device of claim 1 wherein said cooling means cools said at least one wall of said nebulization region to a temperature above the freezing temperature of the solvent and below the temperature of the desolvation section.

4. The device of claim 3 wherein said temperature is within two to twenty degrees Celsius of the freezing temperature.

5. The device of claim 1 further comprising a chromatograph in fluid communication with said nebulizer to provide a source of sample.

6. The device of claim 1 further comprising a condensation nucleation light scattering detector in fluid communication with said analyte port to receive said particulate analyte molecules, if present, and produce a condensation light scattering signal.

7. The device of claim 1 wherein said vessel is an cylinder having a first end and a second end, said a nebulization section at one of said first end and second end and a desolvation section at said remaining end.

8. The device of claim 7 wherein at least one of said nebulization section and said desolvation section is coiled.

9. The device of claim 7 wherein said nebulization section has a larger diameter than said desolvation section in order to contain said plume and waste.

10. A method of making particulate analyte molecules, said analyte molecules potentially present in solution or suspension in a liquid sample having solvent, comprising the steps of:
producing a plume of liquid droplets with a nebulizer placed in fluid communication with a source of sample, said plume having dimensions of length and diameter and extending into a vessel, said vessel having at least one wall defining a chamber, said chamber in fluid communication with said nebulizer to receive said plume, said chamber having a nebulization section, and a desolvation section, a waste port, a analyte molecule port, and a gas inlet, said nebulization section proximal to said nebulizer and having a length at least as great as the plume, said desolvation section distal to said nebulizer to receive droplets and analyte molecules from said nebulization section, forming particulate analyte molecules and solvent gas molecules and passing particulate analyte molecules to said analyte port, said gas inlet having a position in at least one of said nebulization section and desolvation section close to said plume for receiving an inert gas which inert gas carries particulate analyte molecules and solvent gas molecules to said analyte port, said waste port in a position in said nebulization section to receive a portion of said plume that condenses;
cooling said nebulization section to cool said at least one wall to form a condensed waste from a portion of said plume;
heating said desolvation section to heat solvent to form solvent gas molecules and particulate analyte molecules, said particulate analyte molecules carried to said analyte port.

11. The method of claim 10 wherein said cooling means is a Peltier device.

12. The method of claim 10 wherein said cooling cools said at least one wall of said nebulization region to a temperature above the freezing temperature of the solvent and below the temperature of the desolvation section.

13. The method of claim 12 wherein said temperature is within five to twenty degrees Celsius of the freezing temperature.

14. The method of claim 10 wherein a chromatograph is in fluid communication with said nebulizer to provide a source of sample.

15. The method of claim 10 wherein a condensation nucleation light scattering detector is in fluid communication with said analyte port to receive said particulate analyte molecules, if present, to produce a condensation light scattering signal.
